(19) United States
(12) Patent Application Publication
(10) Pub. No.: US 2022/0188474 A1
(43) Pub. Date: Jun. 16, 2022

(54) GEOGRAPHIC LOCATION TOOL FOR ELECTRIC POWER SYSTEMS

(71) Applicant: UT-Battelle, LLC, Oak Ridge, TN (US)

(72) Inventors: Isabelle B. Snyder, Oak Ridge, TN (US); Nils M. Stenvig, Oak Ridge, TN (US); Travis M. Smith, Oak Ridge, TN (US)

(21) Appl. No.: 17/545,010

(22) Filed: Dec. 8, 2021

Related U.S. Application Data
(60) Provisional application No. 63/125,462, filed on Dec. 15, 2020.

(51) Int. Cl. G06F 30/18; G06T 11/20; G06F 16/29

(52) U.S. Cl. CPC G06F 30/18; G06F 2113/06; G06F 16/29; G06T 11/206

(57) ABSTRACT

A method for associating geographic location information with a power system model. The method generally includes the steps of receiving known geographic information for a plurality of power system assets within the model and automatically calculating the geographic information for other power system assets with unknown geographic information based on the imported geographic information and architectural information available within the model. The step of calculating the geographic location information may be performed iteratively initially using only imported geographic information and subsequently using both imported and calculated geographic information. The geographic location of each power system asset with an unknown location may be determined through multilateration based on known locations and branch connection lengths of two or more connections with known geolocations.

### STATEMENT REGARDING FEDERALLY SPONSORED RESEARCH

This invention was made with government support under Contract No. DE-AC05-00OR22725 awarded by the U.S. Department of Energy. The government has certain rights in the invention.

### FIELD OF THE INVENTION

The present invention relates to electrical power systems, and more particularly to systems and methods for incorporating geographic location into electrical power system models.

### BACKGROUND OF THE INVENTION

Electrical power system simulation is a common tool used in analysis and management of electrical power infrastructure. Electrical power system simulation generally involves the modeling of power system infrastructure within modeling systems that allow for a wide range of network simulations to be run on the model. For example, electrical power system simulation allows for limitation analysis, disruption analysis, distribution analysis, network simulations, market analysis and a range of other simulations and analyses that are useful in operational and strategic planning.

Analysis and visualization of certain power systems behavior can, in some situations, depend on the geographic locations of the system's assets. For example, weather events' impact on the power system requires the location of the conventional and renewable generation, substations, and lines. Analysis of cascading events requires the visualization of the model geographically to better understand and correlate the sequence of events. The analysis of generation resources supply chain disturbance, such as natural gas requires geographic location mapping to assess the interdependency.

Although existing simulation systems provide powerful tools for modeling and analyzing power systems, conventional simulation modelling systems generally do not include geographic location information for the power system assets in the model, such as substations and buses. Accordingly, geographic location information must somehow be associated with the assets in the power system model before location-based studies can be performed on a model. Conventional technologies for identifying geographic location information for power systems model is based on assigning the latitude and longitude manually to the system as an input parameter. The location can be manually located, or by mapping the power system to an imagery-based database of the transmission system or using GIS mapping tools such as ESRI, ARCGIS mapping tool or an input from different database such as Energy visual and US Energy mapping system provided by the US Energy Information Administration for example (see https://www.eia.gov/state/maps.php). However, mapping the known location from an existing database to the model under study is a challenging task since the nomenclature and the bus numbers often differ from the GIS database. Existing geographic plots of the United Stated power system assets are available as open-source data. However, the mapping of these locations to an electrical model under study is not straightforward. The geospatial data is derived from satellite imagery, while the electrical models consist mainly of impedance relationships and are built for computational efficiency. There is no straightforward method of assimilating the two data sets. Satellite imagery may also not represent current model topology due to in-place retirement of assets and ongoing construction. Some commercial models of power systems also include geospatial attributes. However, the available data is manually derived and maintained and is of low accuracy.

As a result, there is a need for a method to accurately and efficiently provide geographic locations of power system assets that relies heavily on automation and requires limited human intervention.

### SUMMARY OF THE INVENTION

The present invention provides a method for associating geographic information with power system assets, such as buses, in existing power system simulation models. The method includes the general steps of: (1) importing known geographic information for a plurality of power system assets within the model and (2) automatically calculating the geographic information for power system assets with unknown geographic information based on the imported geographic information and architectural information available within the model. The step of calculating the geographic information for power system assets with unknown geographic information may be performed reiteratively initially using only imported geographic information and subsequently using both imported and calculated geographic information, until there are no remaining power system assets with unknown geographic information that can be determined from imported and calculated known geographic information.

In one embodiment, the process of importing known geographic information includes comparing the power system assets (e.g. substations) in the power system simulation model with a database (e.g. substation database) that includes geographic information (or geolocations) for power system assets. This may include a comparison of the asset names in the model and in the database. When a match between a power system asset in the model and a power system asset in the database is found, the geographic information for that power system asset is associated with the power system asset in the model. This may include incorporating the data directly into the model or maintaining the data separately from the model. The number of power system assets for which geographic information is imported may vary from application to application, but it may be desirable to import geolocations for as many power system assets as possible to provide as much seeding data as possible for calculating geographic information for other power system assets and to reduce the number of power system assets for which geographic information needs to be calculated.

In one embodiment, the architectural information used to calculating geolocations for power system assets with unknown locations includes branch connections (e.g. which power system assets are connected to which other power system assets) and the distance or length values (e.g. the lengths of the branch connections). For example, in one embodiment, the method starts by importing or receiving a set of known locations for a subset of the power system assets, then runs multiple iterations to identify missing locations using a multilateration algorithm based on the known locations and distances to connected power system assets with known geolocations.

In one embodiment, the step of automatically calculating the geographic information for power system assets with unknown geographic information includes the steps of: (a) identifying a power system asset with an unknown location that has two or more branch connections with known locations and (b) determining the location of that power system asset based on the two or more branch connections with known locations. In one embodiment, the determining step includes determining the geographic location of the unknown power system asset through multilateration (e.g. bilateration, trilateration, etc.) based on known locations and branch connection lengths of the two or more connections. For example, in one embodiment, the geographic location of an unknown asset is determined based on the intersection or overlap of a plurality of circles associated with the connected power system assets with a known location. For each connected power system asset with a known location, a circle is provided that is centered on the known location and has a radius corresponding to the branch connection length between that connected power system asset and the unknown power system asset.

In one embodiment, the geolocation of a power system asset may be estimated to be about the center of the region of overlap of the various multilateration circles. In one embodiment, the geolocations estimated by the multilateration algorithm can be compared with a database of trusted geolocations and the power system asset can be associated with the geolocation in the trusted database that is closest to the estimated geolocation.

In some embodiments, the geolocations of the power system assets are provided in degrees latitude and longitude. In such embodiments, the step of multilateration may include the steps of: (a) linearizing the degrees latitude and degrees longitude around the location under study; (b) in the relative XY axis, identifying the intersection of the circles from the known locations with a respective radius corresponding to the line lengths; and (c) converting the XY values in the linear place of the calculated location to degrees latitude and longitude.

Some power system data does not always include the length of branch connections, but does include impedance values and voltage levels. As a result, the data does not always expressly provide branch connection lengths that can be used in the multilateration algorithm. To overcome the issue, the present invention may, in one embodiment, include a method to extrapolate line length data from the impedance values and voltage levels in the power system data. For example, when not provided, the line length values can be estimated by analyzing the correlation between line length, line impedance, and voltage levels from the branch connections with provided length data. A table is created for different voltage levels of Ohms/mile computed values. The ohms/mile values are applied to the missing lengths based on the corresponding voltage level.

In one embodiment, the iterative method of the present invention provides the ability to compute the geospatial attributes of a power system model based on a set of known locations and system architecture, e.g., branch connections and line length. One meaningful advantage of the disclosed technologies is minimizing the mapping process for large models since by assigning a set of known locations the remaining bus location can be interpolated from the system architecture.

In one embodiment, the geographic information for a plurality of power system assets are obtained and used to seed the process. The geographic information can be obtained from a database containing geographic information for power system assets. For example, a number of open source or public domain databases that contain geographic location information for power system assets, such as buses, are available and known to those skilled in the art.

In one embodiment, geolocations are provided in degree of latitude and longitude. In such embodiments, a linearization algorithm may be used to convert degree latitude and longitude to XY linear axis with a reference (0,0) as a median geographic location (Lat_ref, Lon_ref) of the area under calculation.

In one embodiment, an initial set of bus locations are identified by comparing the bus or other power system asset name to a KML database or excel input file that includes geolocation information for a plurality of buses or other power system assets. Once the initial geolocation data is imported, a first iteration is run to identify geolocations of the buses with unknown locations connected to at least two or more buses with known locations. After the first iteration, the program keeps running reiteratively until no new bus location can be identified. If some buses are not located, the steps can be rerun after matching some missing bus locations to a new set of bus input locations manually identified.

The present invention provides an efficient and reliable method for associating geographic location information with power system assets in power system simulation models. The geographic locations of power systems assets are critical to improving the analysis and visualization of the impact of certain events on the power system. Geographic location data is important for different system studies, such as the weather-related impacts on the power systems, situational awareness, cascading events, frequency propagation after major disruptions, and renewable energy distribution and reliability. The present invention provides the ability to assign geographic locations for a power system under study, which could not otherwise be achieved accurately and efficiently by attempting to map the data to a standard database with assets location that does not include all the elements of the power systems under study and does not present identical nomenclature to make the mapping possible. More specifically, direct incorporation of geographic location information from open source databases that contain geographic locations of power systems infrastructure is impractical because known open source databases do not include attributes that directly tie to the power system simulation models. For example, known open source databases do not include branch connections or connection lengths. Moreover, complete reliance on existing databases is not possible because the relationships established between power system models and geospatial data sets generally do not apply to future models because of nomenclature changes and architecture changes. The present invention provides a method that automatically and iteratively calculates geographic location information from an initial seeding of known geographic information. The present invention eliminates the essentially impossible task of matching each power system asset in the power system simulation model with a corresponding asset in a database containing geographic location information. The present invention may include a linearization step that allows latitude/longitude degree information to be linearized for use in multilateration and then returned to latitude/longitude degree information for mapping purposes. The reliability of the method may be enhanced by matching each geographic location calculated by the method with the closest asset location contained in a trusted database of power system asset locations. The present invention provides a method that quickly and easily obtains geographic location information for ever-changing models, thereby facilitating use with changing infrastructure and modeling techniques.

These and other features of the invention will be more fully understood and appreciated by reference to the description of the embodiments and the drawings.

### BRIEF DESCRIPTION OF THE DRAWINGS

This patent or application file contains at least one drawing executed in color. Copies of this patent or patent application with color drawing(s) will be provided by the Office upon request and payment of the necessary fee.

FIG. 1 is a map showing the boundaries of the Eastern Interconnection Service Areas.

FIG. 2 is a plot showing latitude degrees/mile coefficient versus degree latitude.

FIG. 3 is an illustration showing the multilateration algorithm principle.

FIG. 4 is a flow chart of the general step of one embodiment of the present invention.

FIG. 5 is a graphic user interface used in the implementation of one embodiment of the present invention.

FIG. 6 is an illustration showing an algorithm for implementing an expanded tolerance.

FIG. 7 is a map showing a one-line diagram generated from the geo-location information obtained through the present invention.

FIG. 8 is a geographic representation of Scaling Factor for GMD study (α·β in Equation 3).

FIG. 9 are maps showing renewable generation identified in the Eastern Interconnect Power System model (right) and EIA database wind plant locations in the US (Left).

FIG. 10 are maps showing Power System per unit voltage variation before and after the loss of 40% of wind generation.

FIG. 11 is an illustration showing integration of geolocation and contingency analysis based on weather events path.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DESCRIPTION OF CURRENT EMBODIMENTS

Overview.

The present invention provides a method for associating geographic location information with the power system assets in a power system simulation model, which allows for a wide range of enhanced studies of the model that involve geographic information. The method generally includes the steps of: (a) importing geographic location information for a subset of power system assets in the simulation model and (b) iteratively calculating geographic location information for power system assets with unknown geographic location information based on the imported geographic location information and system architectural information available in the power system model. More specifically, in one embodiment, the step of calculating geographic location information implements a multilateration algorithm based on known locations, connection information (e.g. the branch connections between different power system assets) and distance information (e.g. the length of the branch connections) present in the power system model. The term “multilateration” is used broadly herein to refer to bilateration, trilateration, quad-lateration and all other algorithms capable of determining the unknown location of an asset based on the known location of two or more other assets and the distances therebetween. During each iteration of the calculating step, geographic location information is calculated for each power system asset with unknown geographic location information that is connected to at least two power system assets with known geographic location information. For each such unknown power system asset, the multilateration algorithm is implemented to determine the geographic location. Once the location of an unknown power system asset is determined, that power system asset become a known power system asset which known geographic location information that is available for use in subsequent iterations.

The method is implemented reiteratively until the geographic location for all power system assets has been determined. If the method is unable to assign geographic location information to all of the power system assets (e.g. no remaining power system assets have at least two connections to power system assets with known geographic information), additional geographic location information can be imported and the iterative calculating step can be repeated taking into account the newly imported geographic location information. This process of seeding with additional geographic location information and repeating the iterative calculating step can repeated until locations are determined for all power system assets.

Once the method is complete, the modeled power system can be mapped using the associated geographic location information, for example, in a one-line drawing, to allow visualization of the power system and its various elements. The geographic location information can also be used in performing numerical analyses and other studies on the power system model.

The method may be implemented using any suitable computer, controller, processor or other data processing apparatus capable of being programmed to implement the steps of the present invention. For example, the present invention maybe implemented on a general-purpose computer having a processor (e.g. CPU), memory (e.g. RAM), storage (e.g. hard drive), wired/wireless communications systems (e.g. Ethernet, WiFi, Bluetooth) and human interface devices (e.g. monitor, touchscreen, mouse, touchpad, stylus and/or keyboard). The general-purpose computer may be running software/programming configured to implement the method steps set forth in this disclosure. The computer may, if desired, be connected to a local area network or wide area network (wired or wirelessly) and may access data that is store locally or remotely.

Geographic Location Method.

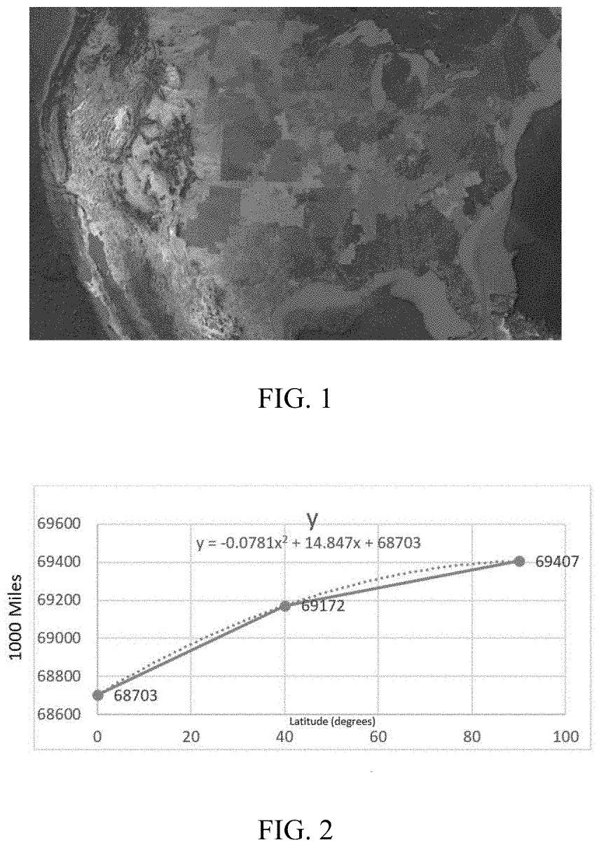

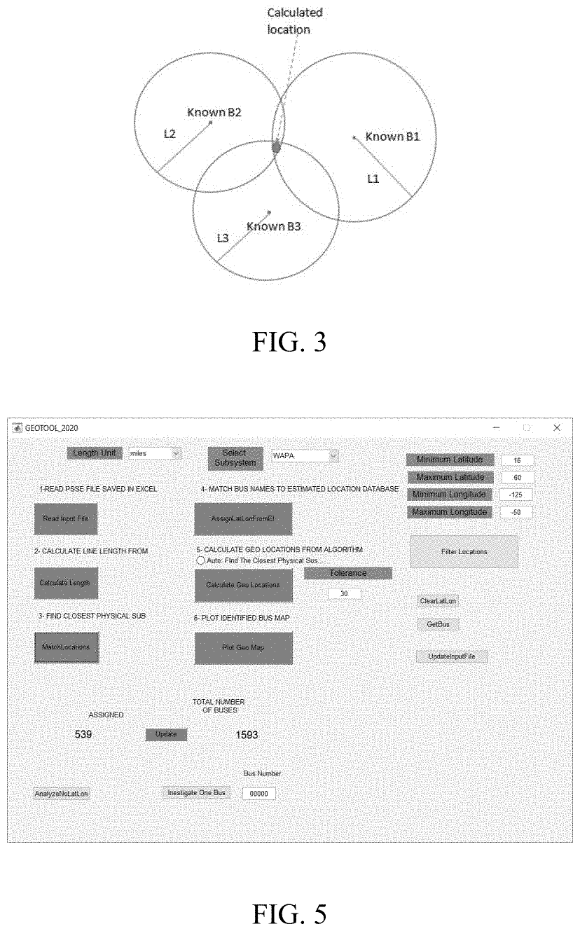

One embodiment of the present invention will now be described in connection with FIGS. 1-11. As noted above, the present invention provides a method for associating geographic location information with the power system assets in a power system simulation model. The present invention may be implemented in connection with a wide range of different simulation modeling systems. In the illustrated embodiment, the power system simulation model is generated using the Power System Simulator for Engineering modeling system. This power system simulation model is merely exemplary and the present invention may be used to associated geographic location information with models generated using essentially any other modeling system.

I. Methods and Procedures.

A. Algorithm Principle

In this embodiment, the present invention is aimed at identifying missing substations' geographic location based on a multilateration principle in which the known locations of a plurality substations or buses are imported to provide a seeding from which the locations of other buses can be calculated using the known locations in combination with architecture information contained in the power system simulation model.

The original set of locations is initially identified by comparing the names of the substations in the model to a substation database. The power system model input parameters used in this algorithm are:
Bus Names, corresponding service area, and rated voltage level
Branch connections with line length values
Transformers list and corresponding bus names of primary, secondary, and tertiary (if applicable)

In the illustrated embodiment, the names of the substations in the model are compared to an Eastern Interconnect database with geographical location identified manually in a collaboration effort between ORNL and University of TN substation database, which included geographic location information for some of the substations included in the database. The use of this database is merely exemplary, and geographic location information may be imported from alternative additional sources, such as the EIA database or the ORNL open source database identified below.

B. Create a lookup table to identify line length from impedance

In the illustrated embodiment, the multilateration algorithm used to calculate the geographic location of a bus with unknown location information relies, in part, on the distance between that bus and two or more connected buses with known location information. While line length (or branch connection length) is often included in the data, line length data is sometime missing from the power system model. Since the line length data is not always available as part of the system data, the present invention includes a method for approximating line length data from information that is available in the model. In this example, the Ohm/mile value is estimated for each voltage level and saved in a reference table used to identify the missing line length data by using the Ohm/mile in the lookup table. The lookup table is created using line length, impedance, and voltage levels values from the data set in the models that provide all three parameters (Impedance, Voltage, and Line Length). Table 1 below shows a sample of a lookup table identified from a given set of data.

### Table of Miles/Ohms Generated from Power System Data

TABLE 1
Impedance (Ω)/Mile versus Voltage
calculated from Power System data

| V(kV) | Z (Ω/mile) |
|---|---|
| 13.8 | 0.15 |
| 34.5 | 0.71 |
| 69 | 0.77 |
| 138 | 0.75 |
| 161 | 0.76 |
| 230 | 0.76 |
| 315 | 0.53 |
| 345 | 0.63 |
| 500 | 0.55 |
| 735 | 0.48 |
| 765 | 0.52 |

C. Match Initial Locations to a Substations Database

To enhance accuracy, the present invention may compare each location identified by the system with a trusted database. For example, the process of matching locations found to the closest substations location from a trusted database may be used throughout the algorithm for every new location found. In the illustrated embodiment, the known trusted substation locations used in the algorithm are based on an Open Source database created at Oak Ridge National Laboratories (“ORNL”) from visual aerial identification of the United Stated powers system infrastructure assets and EIA database combined. This Open Source database is available at https://hifld-geoplatform.opendata.arcgis.com/.

D. Assign and Check Model Geo Locations to Initial Locations

1. Assigning Geo Locations from Initial Location Database to Power System Model Understudy

After matching the initial locations to the closest known physical substation location, the power system model bus names are compared to that database and exact matches are assigned if the assigned locations are in the correct service area boundaries. For example, FIG. 1 is a map of the Eastern Interconnection Service Area Boundaries, which may provide a reference for use in determining whether an assigned location is in the correct service area boundary. In this embodiment, when the system determines an exact match between the bus name used in the power system model and the bus name used in the geographic location database, the system compares the geographic location information with the service area identified in the power system model. If the geographic location provided by the database is within the proper service area, the geographic location is associated with that bus in the power system model.

2. Validity Check of Power System Model Understudy

The present invention may include supplemental steps intended to assist in ensuring the validity of the initial assignments of geographic information. In this embodiment, after the first set of buses/substations are identified from the initial set of data, the following checks are done to filter incorrect assignments:
If transformers primary, secondary or tertiary have different locations, then check the known coordinate of connected branches to the transformer and identify which of the primary or secondary bus is closer to the connected branches and assign a common location to transformer buses.
For all known branch locations, calculate the line length from the assigned geographic location and compare it to the estimated or given line length with the input data set of the power system. Consequently, check the connections of known locations to both branch terminals and maintain the location of the terminal that is closer to the known connection and reset the other terminal to be recalculated with the tool.

E. Identify Missing Locations with Multilateration Algorithm

In the illustrated embodiment, the method includes the step of identifying the geographic location of the buses with a multilateration algorithm.

1. Linearization of Geo-Location in Degrees Latitude and Degrees Longitude to a Linear Axis

In the illustrated embodiment, the method involves the importation of geographic information in degrees latitude and degrees longitude. The linear distance between degrees latitude and between degrees longitude is relative and varies over the surface of the earth. More specifically, the values in miles of each degree latitude and each degree longitude depend on the locations based on the latitude. Accordingly, the linearization of the geo-locations from degrees latitude and degrees longitude is beneficial when applying the principle of multilateration in the linear axis.

The degree longitude/mile value varies considerably with the latitude of the geographic point. At both poles, all longitude points are at the same point and it increases as it gets closer to the parallel where the latitude is 0. The relation between the degree longitude/mile versus latitude is presented in Equation 1, which provides a correlation between Longitude degree/mile coefficient to the degree latitude of the geographic point.

$$Coef\_Lon ( degree / mile ) = 69 * cos ( Lat * \frac{π}{180} ) \qquad Equation 1$$

The degree latitude/mile value varies slightly with the latitude of the geographic point. At the equator (Lat=0 degrees) each degree latitude is equivalent to 68.703 miles. At the pole (Lat=+/−90 degrees), each degree latitude is equivalent to 69.407 miles. At Lat=+/−40 degrees, each degree latitude is equivalent to 69.172.

The quadratic equation is used to convert the difference in degrees to miles at each latitude is presented in Equation 2, which provides a correlation between Latitude degree/mile coefficient to the degree latitude of the geographic point.

Coef_Lat(degree/mile)=−7.81e⁻⁵Lat²+0.0148Lat+68.7 Equation 2:

To linearize a set of geographic locations with latitude and longitude coordinates in the illustrated embodiment, a reference geographic point is used, and delta X and delta Y are calculated using the latitude and longitude coefficients to convert degrees to miles. For example, in the illustrated embodiment, the linearization process includes the steps of:
a. Defining a georeference: (Lat_ref lon_Ref);
b. Finding a Coef_Lat(degree/mile) and a Coef_Lon(degree/mile) at the georeferenced; and
b. Calculate XLat and YLon of the geographic point (Lat, Lon) in an axis where the reference XLat_ref=0 and YLat_ref=0 using the following equations:

XLat=Coef_Lat*(Lat−Lat_Ref)

YLon=Coef_Lon*(Lon−Lon_Ref)

2. Multilateration Principle

As noted above, the method of the present invention implements a multilateration algorithm that allows the geographic location of a bus to be determined when that bus is connected to at least two other buses with known geographic location and distance information.

In the illustrated embodiment, the buses with two or more connections with known locations are identified and the geolocation is linearized as described above. The calculation of the unknown location is based on the linearized coordinate and finding the intersections of the circles with a linearized center and radius corresponding to the branch line length of each connection.

In the illustrated embodiment, the geographic location is determined as a function of the intersection or overlap of the multilateration circles. For example, the geolocation of the bus may be estimated to be the center or approximate center of the region of overlap of the multilateration circles. In the illustrated embodiment, the estimated geolocation determined using the multilateration algorithm is compared with a trusted database that contains known locations of actual substations and the bus is assigned the location of the closest existing substation.

II. Algorithm Flow Chart.

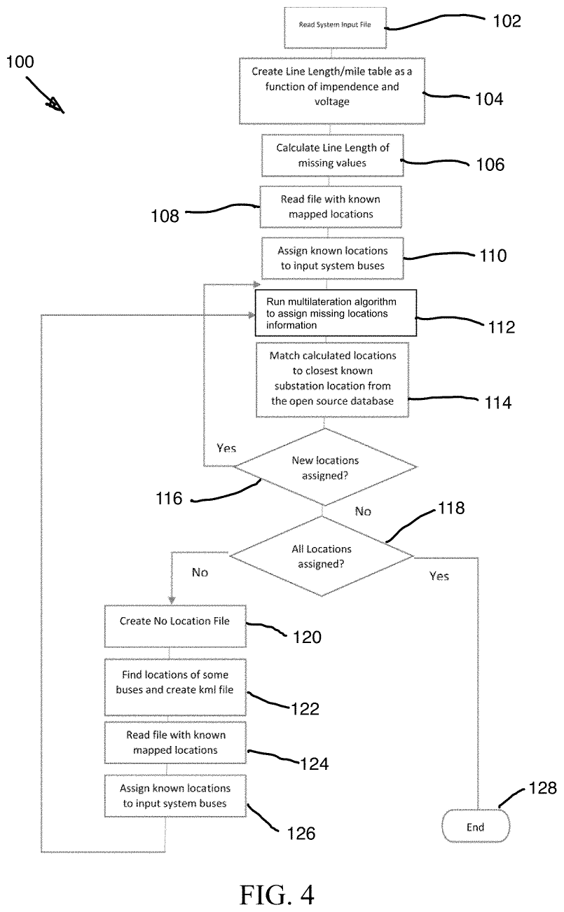

One embodiment of the present invention will now be described in connection with the flow chart of FIG. 4 and the graphical user interface of FIG. 5. FIG. 4 is a flow chart showing the general steps of the method 100 in accordance with one embodiment of the present invention.

In the illustrated embodiment, a graphical user interface is provided to facilitate data entry, running the program, and changing select tolerance parameters. An exemplary graphical user interface is shown in FIG. 5. In this embodiment, the graphical user interface includes buttons for initiating various steps of the method, as well as input fields for inputting select tolerance parameters. For example, the graphic user interface of FIG. 5 includes, among other things, the following buttons: Read Input File button; Calculate Length button; Match Locations button; AssignLatLonFrom EI button; Read_T_Bus button; Calculate Geo Locations button; Add Loc From kml File button; Save Location File button; and UpdateInputFile Button. Further, the graphic user interface of FIG. 5 includes, among other things, input fields: Minium Latitude input, Maximum Latitude input, Minimum Longitude input and Maximum Longitude input, Tolerance input, and MinZeroImpedance input. The graphical user interface may vary from application to application, and may be eliminated in some embodiments of the present invention.

Step 1: Read Input Data.

Referring now to FIG. 4, the method of the illustrated embodiment begins by reading, importing or otherwise receiving the power system model data 102.

The present invention may be configured to operate with power system modeling data and power asset location data presented in essentially any format. In the illustrated embodiment, the Inputs file containing the power system data set for the power system simulation model can be in excel format. The data may, for example, be exported in a model data set format from a power system simulation software package, such as Power System Simulator for Engineering (“PSSE” or “PSS/E”).

In this embodiment, the system reads power system architecture input data from the Inputs file which, in this embodiment, includes:
Bus Info (Bus Number, Name, Area and Voltage level); and
Branch data (From and To Bus number, Impedance, and most of the time branch length info in miles or km).

Step 2: Calculate Line Length for Missing Line Length Branches from Line Impedance Values

As noted above, the multilateration process may be based, in part, on line length information associated with branch connections. In some applications, the power system model may not include line length information for all of the branches. When this occurs, the line length information may be determined by the system. During or after reading the input data, the system may determine the line length values for those buses that do not include line length data. If the line length info is missing from a certain bus or a certain area, the system evaluates the given line length data and correlates them to the voltage levels and impedance (in Ohm) and apply the line Length/Ohm value for each voltage level to the corresponding voltage level from the missing data and multiply the calculated Length/Ohm value to the impedance of the branches without length values. For example, referring again to FIG. 4, the method includes the steps of: (i) creating the line length/mile table 104 as a function of the impedance and voltage information from branch connections that include line length information (as discussed above in connection with Table 2) and (ii) calculating the line lengths 106 for each branch connections that is missing line length information based on the line length/mile table and the voltage/impedance information for that branch connection.

Step 3: Associate Initial Bus Location

In the illustrated embodiment, the initial geographic location information is read or otherwise imported from one or more location input files 108. The location input file(s) can be in either excel or Keyhole Markup Language (“KML”) format, but the system can be readily configured to work with location input files of other formats.

An initial set of known bus location is assigned 110 from the location input file. The initial set of geographic location data is assigned by comparing the bus names in the power system model with the bus names in the location input file (e.g. a KML file or an excel file with a plurality of Bus Numbers and Latitude and Longitude data). In this embodiment, the power system model bus will be considered a match with a bus in the location input file when there is a match in the bus name or bus numbers and they are in the same service area.

To optimize the multilateration algorithm used to calculate geographic location information for buses without geographic location information, the buses with most connections can be identified from the tool (“AnalyzeNoLatLon” button) and sorted in descending order based on the total number of connections. The top buses could be used to be part of the initial set of identified locations.

Step 4: Iterative Multilateration Algorithm

After importation of a set of known geographic locations, an iterative multilateration algorithm is run 112 to find the location of the remaining buses using the known buses connected to the unknown bus location and different line length values.

As described above, the multilateration algorithm is based first on a linearization step of the degrees latitude and longitude around the location under study, then in the relative XY axis, the intersection or overlap of the circles from the know location with a respective radius corresponding to the line length is identified. For example, when the circles provide an area of overlap, the approximate center of the region of overlap can be determined and can be the estimated location of the bus. Then the X, Y values in the linear plane of the calculated location are converted to degrees latitude and longitude. Multilateration algorithms are well known to those skilled in the field.

If desired, the accuracy and reliability of the method can be enhanced by comparing and potentially adjusting all calculated geographic locations with a trusted database of power system asset geographic location information. In the illustrated embodiment, every new location found through the multilateration algorithm is compared to a known database of actual substations and the latitude and longitude of the closest existing substation to the calculated location are assigned by the tool 114.

Step 4 is repeated 116 until no more new locations can be identified. Once the geographic location information for an unknown bus is determined, that bus becomes a bus with known geographic location information and it can be used in subsequent iterations of the multilateration algorithm, thereby allowing calculated geographic information to cascade through the model. Accordingly, as long as one or more new locations are identified during an iteration of the multilateration algorithm there is potential for a subsequent iteration to identify additional new locations.

If Step 4 is performed and no new location are identified, but buses with unknown locations remain 118, additional location information can be imported or otherwise received to provide additional seeding data to allow the multilateration algorithm to calculate additional unknown locations. For example, in this embodiment a “No Location File” is created 120 and is populated with geolocation data for one or more of the remaining buses with unknown locations. In this embodiment, the No Location File is a KML file that is populated by finding location data for one or more of the remaining buses without location information. The location data can be identified by comparing the remaining unknown buses with a file or database containing bus geolocation information. Alternatively, the information can be located manually using mapping programs that show power system assets and provide corresponding geolocation information. In the illustrated embodiment, the remaining unknown buses are sorted by the number of associated branch connections in descending order and geographic location information is obtained for the buses with the largest number of branch connections. The number of buses for which geographic location information is obtained for re-seeding may vary from application to application, but in a typical application may be in the range of 10% to 20% of total buses. If geolocation information is not readily available for one or more of the buses with the greatest numbers of branch connections, that bus may be skipped in favor of a bus for which geolocation is more easily obtained.

Regardless of how the geolocation information is obtained, the new geolocation information is, in this embodiment, incorporated into the No Location File 122. The No Location File with the new geolocation information can then be read by the system 124 and the new geolocation information can be assigned 126 to the corresponding buses in power system model. Control is then returned to the multilateration algorithm for the implementation of one or more additional iterations in which the new geolocation information provides a supplement to the previously imported and previously calculated geolocation information. This process can be repeated as desired until geographic location information has been assigned to all of the buses in the power system model.

When geographic location information has been assigned to all of the buses or other power system assets in the power system model, the process ends 128 and the assigned geolocation data can be used in combination with the power system model as desired.

Step 5: Tolerance Change

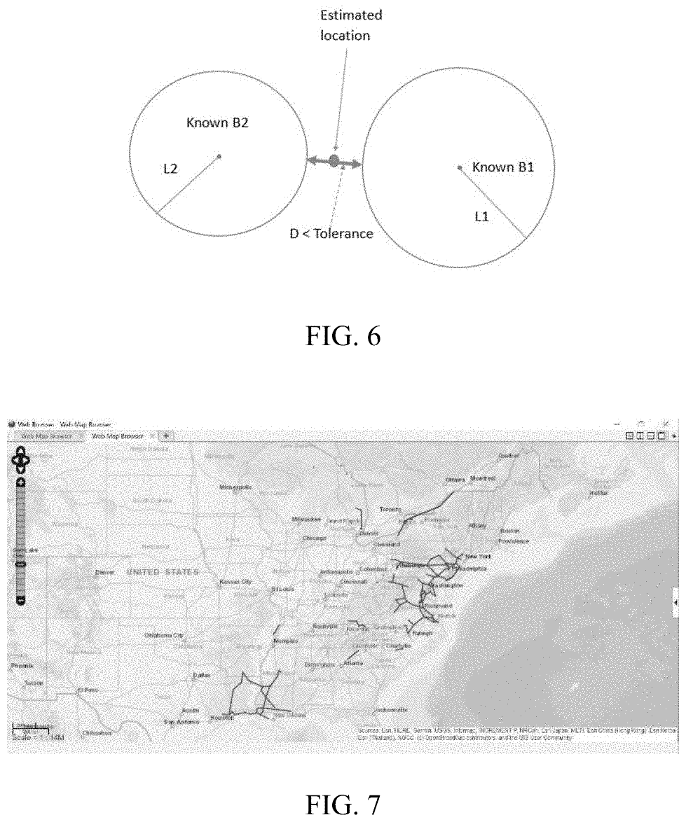

The present invention may include one or more additional procedures that help locate geographic location information when the multilateration algorithm is not able to calculate geographic location information for all of buses. This may happen, for example, when the circles used in the multilateration algorithm do not overlap or do not intersect. When that occurs, the tolerance level can be loosened to try to identify the geographic location information for those buses or substations. If the multilateration step did not find an intersection between the different circles from known locations, the system may find, based on the tolerance level, the closest point to all circumferences and assign it to the missing bus if the distance of the calculated location to each circle is within the defined tolerance. For example, FIG. 6 illustrates an example in which an unknown bus has two connections with known locations, B1 and B2, of lengths, L1 and L2, respectively. As shown, the multilateration step does not find an intersection between the L1 and L2 radius circles for those two known locations. When this occurs, the system may attempt to estimate the location of the unknown bus by determining the closest point to the two circles. If the closet point to the two circles is less than a tolerance, the location of the closest point will be associated with the unknown bus. The tolerance may be user defined, and may be increased over time as may be needed to assist in identifying locations that remain unknown.

In the illustrated embodiment, another tolerance factor can be modified. This tolerance factor corresponds to the maximum line length under which the two buses are considered in the same substation. For example, if that tolerance factor is set to 0.1, all buses within 0.1 miles from a known bus are assigned the same location. This tolerance factor may be user defined, and may be increased over time as may be needed to assist in identifying locations that remain unknown.

These procedures for adjusting tolerances may be taken in addition or as an alternative to re-seeding the multilateration algorithm with new geolocation information, as described above. For example, in one embodiment, the multilateration algorithm will be re-seeded with additional geographic information and re-run until it becomes sufficiently difficult to obtain additional geographic information for remaining unknown buses, after which one or both of the tolerance noted above can be adjusted to help in assigning geographic location information to the remaining unknown buses.

Step 6: Plot the System One Line Diagram or Bus Locations

Once the geographic location information for all of the buses/substations has been determined, the power system can be plotted, for example, in a one-line diagram. A variety of systems and methods for producing one-line diagrams with power system models that include geographic location information are known to those skilled in the field. If desired, the graphic locations to be plotted can be filtered by Area and voltage levels.

In one example, a system implementing a method in accordance with one embodiment of the present invention was used to provide geographic location information to a power system model with approximately 84,000 buses. After the initial run of the tool, 67,400 buses were identified with the multilateration algorithm. For the remaining 17,000 buses, the missing buses were sorted in descending order based on their number of connections, the geographic location information for the buses with the most connections were then identified manually to re-seed the multilateration algorithm and a new iteration was run after populating the new strategically assigned locations. The final run was performed by loosening the tolerance from 2 miles to 5 miles as described above.

Geographic Location-Based Studies.

The geo-location information made available by the present invention facilitates a wide range of geographic location-based studies.

A. Geomagnetic Disturbance.

Geographic location identification is crucial for Geomagnetic disturbance analysis of a power system. The location of the bus determines the scaling factor used in the calculation. The geoelectric field peak amplitude, Eₚₑₐₖ, that is considered for the GMD vulnerability assessment varies for different geographical regions, and can be obtained from a reference geoelectric field E_{ref} specified for a latitude, using the following relationship:

Eₚₑₐₖ=Eₚₑₐₖαβ(V/km), (3)

Where, following the NERC benchmark [5], E_{ref}=8 V/km, α is the scaling factor to account for local geomagnetic latitude, and β is the scaling factor to account for local earth conductivity.

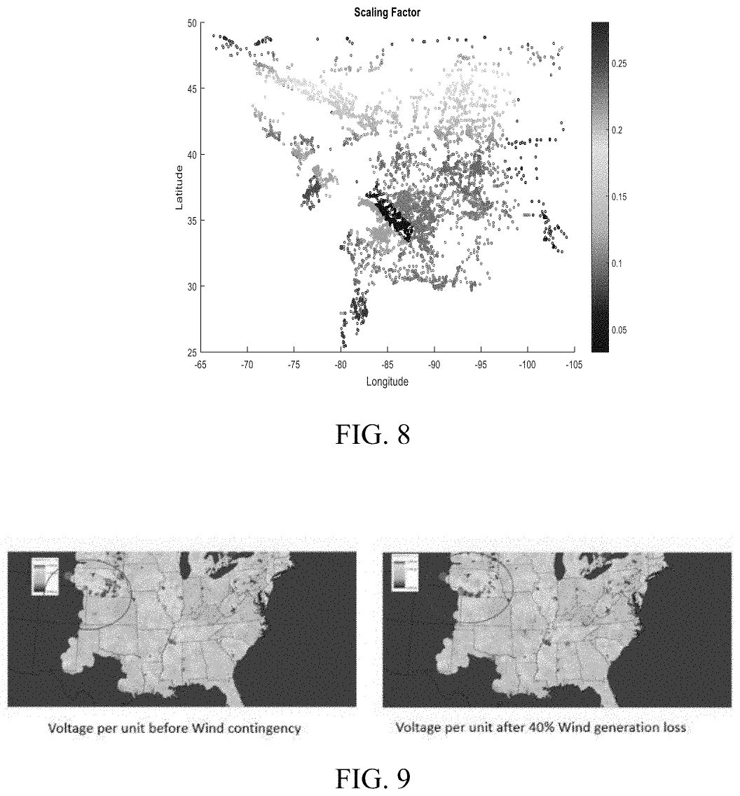

FIG. 8 shows the total scaling factor α·β for the geoelectric field calculated for the Eastern Interconnect model, based on geographic locations of the different lines in the model. The highest values of the scaling factor are found in the upper section of the latitude, with some fluctuations due to the variation in resistivity.

B. Impact of Renewable Generation Loss.

FIG. 9 shows the location of the renewable energy located from the Eastern Interconnect power system model under study. The locations are identified with the geo-location tool and compared to the wind EIA database [3]

After locating the wind plant, the impact on the power system due to wind generation loss is analyzed and the voltage profile deviation is presented in FIG. 10.

FIG. 10 shows the system per unit voltage variation before and after the loss of 40% of wind generation. Additional technical details are described in the ANNEX. After the contingencies, the voltage decreases in the affected area but remains close to 1 pu. Conventional generation is available to compensate for the loss of wind generation in this scenario.

C. Contingency Events Based on Weather Trajectory.

Weather events' impact on power systems depends closely on the path of the event and the available power systems assets in its path. The location of power system assets is critical to better assess the gravity of a certain weather event in a specific area. The geographic locations identified are used in conjunction with a Protection/Dynamic simulation tool (CAPE/PSSE Integration) to assess the sequence of protection events induced by consecutive line losses due to a severe weather path.

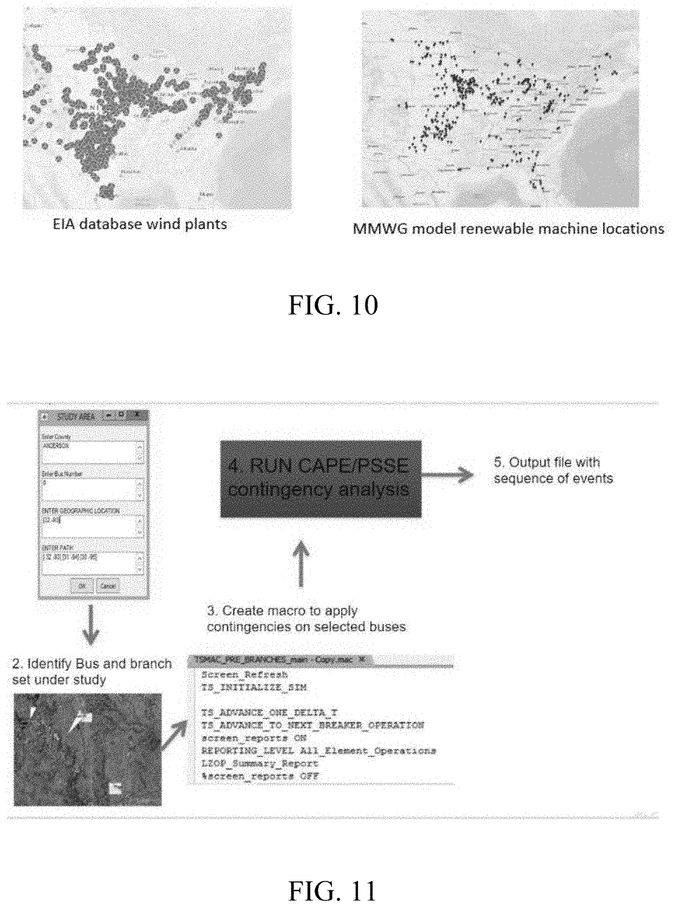

FIG. 11 shows the process flow used to identify the consequences of weather events on the power system as a weather event is in progress with a projected path.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method for geographically locating a plurality of buses of a power system, wherein the buses are distributed over a geographic area, and each bus of the plurality is electrically connected through respective branches to one or more other buses of the plurality, the method comprising:
receiving, for the plurality of buses, architecture information that includes
bus information including one or more of bus number, name, and voltage level, and
branch information including one or more of from-and-to bus numbers, branch impedance, and length;
receiving geographic information that includes numbers or names and corresponding geolocations for a subset of the plurality of buses;
matching buses from the plurality associated with the architecture information with the buses from the subset associated with the geographic information based on corresponding bus numbers or names; and
determining geolocations for the unmatched buses of the plurality by calculating, for each unmatched bus, its respective geolocation based on lengths of branches between the unmatched bus and two or more matched buses.

2. The method of claim 1, wherein calculating the geolocation of the unmatched bus comprises identifying an intersection area of three overlapping circles having as centers respective geolocations of three matched buses and as radii respective lengths of branches between the three matched buses and the unmatched bus.

3. The method of claim 1, wherein calculating the geolocation of the unmatched bus is performed using multilateration.

4. The method of claim 1, wherein calculating the geolocation of the unmatched bus comprises estimating a separation between at least two non-overlapping circles having as centers respective geolocations of at least two matched buses and as radii respective lengths of branches between the at least two matched buses and the unmatched bus.

5. The method of claim 4, wherein calculating the geolocation of the unmatched bus includes estimating the closest point to the at least two non-overlapping circles.

6. The method of claim 1, wherein
the geolocations of the buses including the received geographic information is expressed in latitude and longitude values, and
calculating geolocations of unmatched buses comprises converting
the latitude values to corresponding linearized values of distances from a reference parallel, and
the longitude values to corresponding linearized values of distances from a reference meridian.

7. The method of claim 6, wherein calculating the geolocation of the unmatched bus includes converting the calculated geolocations from linearized values back to latitude and longitude values.

8. The method of claim 1, wherein
calculating geolocations of unmatched buses is performed iteratively based on lengths of branches between the unmatched bus and two or more matched buses, and
the matched buses are from among the subset and/or from previously unmatched buses of the plurality for which their corresponding geolocations have been calculated in previous iterations.

9. The method of claim 1, wherein, when the branch information for at least some of the buses of the plurality lacks corresponding length values, the method further comprises determining the length values based on corresponding bus-voltage values and corresponding branch impedance values.

10. The method of claim 9, wherein the step of determining the length values includes building a table of bus-voltage values and corresponding branch impedance values and calculating the length values using the table.

11. The method of claim 1, wherein the buses comprise respective substations of the power system.

12. A method for associating geolocation information with a plurality of buses of a modeled power system, wherein the buses are distributed over a geographic area, and each bus of the plurality is electrically connected through respective branches to one or more other buses of the plurality, the method comprising:
reading a system input file containing architectural information for the modeled power system for a plurality of buses, the architecture information including, for the plurality of buses:
bus information including one or more of bus number, name, and voltage level, and
branch information including one or more of from-and-to bus numbers, branch impedance, and length;
creating a table of impedance and voltage information from branch information that includes branch impedance and length information;
calculating from the table the length values for each branch that includes branch impedance information but not length information;
reading a geographic information file that includes numbers or names and corresponding geolocations for a subset of the plurality of buses;
matching buses from the plurality associated with the architecture information with the buses from the subset associated with the geographic information based on corresponding bus numbers or names;
determining geolocations for the unmatched buses of the plurality by calculating, for each unmatched bus, its respective geolocation based on lengths of branches between the unmatched bus and two or more matched buses; and
reiteratively repeating the step of determining geolocations with the buses and calculated geolocations from prior iterations being matched buses for subsequent iterations.

13. Memory encoding instructions that when executed by data processing apparatus cause the data processing apparatus to perform the methods of claim 1.

14. The memory of claim 13, wherein the instructions cause the data processing apparatus to present a user interface that prompts the user to request access to
the architecture information in a power system data repository, and
the geographic information in a geoinformation system data repository.

15. The memory of claim 14, wherein the instructions cause the data processing apparatus to calculate the geolocation of the unmatched bus by identifying an intersection area of two or more overlapping circles having as centers respective geolocations of two or more matched buses and as radii respective lengths of branches between the two or more matched buses and the unmatched bus.

16. The memory of claim 15, wherein the instructions cause the data processing apparatus to reiteratively perform the step of determining geolocations with the buses and calculated geolocations from prior iterations being matched buses for subsequent iterations.

17. The memory of claim 16, wherein the instructions cause the data processing apparatus to perform the step of determining the length value based on corresponding bus-voltage values and corresponding branch impedance values, when the branch information for a bus of the plurality lacks a corresponding length value.

18. The memory of claim 16, wherein the instructions cause the data processing apparatus to perform the step of calculating the geolocation of the unmatched bus by estimating a separation between at least two non-overlapping circles having as centers respective geolocations of at least two matched buses and as radii respective lengths of branches between the at least two matched buses and the unmatched bus.

19. The memory of claim 18, wherein the instructions cause the data processing apparatus to perform the step of calculating the geolocation of the unmatched bus by estimating the closest point to the at least two non-overlapping circles.

20. The memory of claim 13, wherein the instructions cause the data processing apparatus to perform the steps of, for each bus for which a geolocation is calculated, comparing the calculated geolocation with a trusted database of bus geolocations and associating with that bus the closest geolocation from the trusted database of geolocation.
